(19) United States
(12) Patent Application Publication
(10) Pub. No.: US 2007/0228183 A1
(43) Pub. Date: Oct. 4, 2007

(54) THERMOSTAT

(76) Inventors: Kimberly A. Kennedy, St. Louis, MO (US); Jeffrey Edgar, Saint Charles, MO (US)

Correspondence Address: ANDERSON, LEVINE & LINTEL L.L.P., 14785 PRESTON ROAD, SUITE 650, DALLAS, TX, 75254, US

(21) Appl. No.: 11/690,684

(22) Filed: Mar. 23, 2007

Related U.S. Application Data
(60) Provisional application No. 60/786,635, filed on Mar. 28, 2006.
(60) Provisional application No. 60/746,730, filed on May 8, 2006.
(60) Provisional application No. 60/825,800, filed on Sep. 15, 2006.
(60) Provisional application No. 60/827,204, filed on Sep. 27, 2006.

(51) Int. Cl. G05D 23/12; B64D 13/00

(52) U.S. Cl. 236/1 C; 236/91 D

(57) ABSTRACT

An thermostat 10 includes an improved user interface, including automatic scheduling, remote control, system failure warning messages, and Energy Star compliance messages. Diagnostics can be provided without additional communication links to the thermostat. A sub-base accepts multiple thermostats and uses color coded terminals to ease installation. Glow-in-the-dark features reduce power needs. In one embodiment, thermostats are coupled to AC power sources and communicate using wireless communications to control an HVAC system. A dampered system can be effected through a thermostat that communicates directly with zoned dampers.

### CROSS-REFERENCE TO RELATED APPLICATIONS

This application claims the benefit of the filing date of copending provisional application U.S. Ser. No. 60/786,635, filed Mar. 28, 2006, U.S. Ser. No. 60/746,730 filed May 8, 2006, U.S. Ser. No. 60/825,800 filed Sep. 15, 2006 and U.S. Ser. No. 60/827,204 filed Sep. 27, 2006, which are incorporated by reference herein.

### STATEMENT OF FEDERALLY SPONSORED RESEARCH OR DEVELOPMENT

Not Applicable

### BACKGROUND OF THE INVENTION

1. Technical Field

This invention relates in general to heating and air conditioning systems and, more particularly, to an improved thermostat for a heating and air conditioning system.

2. Description of the Related Art

A home's air conditioning system, which could include a heating furnace and/or a cooling coil, is one of the most important appliances in a home or business setting. Not only is the air conditioning system one of the most expensive appliances in a home or business, the proper operation of the air conditioning system is an ongoing concern. A less-than-optimally performing system can cause discomfort to the occupants and it can also result in wasted energy and money.

Over the last decade, many improvements have been made to controlling the air conditioning system. One of the most important improvements has been the digital thermostat, more specifically, the programmable digital thermostat, which can change temperatures based on a preset schedule according to the time of day. This allows users to reduce air conditioning requirements during times that the dwelling is unoccupied. Unfortunately, full usage of digital thermostats has been hampered by a number of factors.

One factor is that programming the thermostats is generally not intuitive. Thus, many users tend to leave the thermostat on the default setting rather than learn how to program the thermostat for optimal operation. This inevitably leads to the user pressing the “hold temperature” button at a time where the default setting does not match the user's schedule, thereby negating the set-back abilities of the thermostat. Another problem is poor programming by those that have the resolve to program the thermostat, but not knowledge of proper temperature settings. In many cases, the user can make the air conditioning system less energy efficient by programming the thermostat with temperatures outside of established energy efficient settings. These established energy efficient settings are most commonly referenced as be the Energy Star guidelines issued by the EPA.

Another factor is the powering of the digital thermostat, which include semiconductor circuitry and LCD displays. There are basically three ways to power a thermostat. A first method is to use 24V power from the HVAC system transformer(s), to which the thermostat is coupled. This is often referred to in the HVAC industry as a “hardwired” or “5 wire” system. In general, while a 24V line is available, a common line is not—thus, the installer must run a common line from the HVAC control board to the thermostat. This may be difficult or impossible in some dwellings. A second method to power the digital thermostat is to use batteries. This is often referred to in the HVAC industry as a “4 wire system.” The use of batteries has several shortcomings. First, the batteries need to be replaced periodically, and for many people, this requires a service call, particularly if the batteries are not standard batteries. Second, while batteries may last for several years in a thermostat with basic functionality, additional functionality will require greater computing power and thus drain the batteries more rapidly.

A third option to power a digital thermostat is referred to as “power stealing”. Using power stealing, the 24V power connection is used without a common. This severely limits the current to the circuitry of the thermostat, and hence its functionality. This method can sometimes cause system “feedback” which may cause contactors and other system controls to operate in a manner not intended.

Installation is another problem which has thwarted the widespread adoption of digital thermostats. The wiring of a thermostat may depend upon what type of system it is controlling: single stage gas, multistate gas, single stage heat pump, multi-stage heat pump, and so on. Changing a thermostat requires a user to know enough about the system to make wiring decisions. Since few people have an intricate knowledge of their system, it is intimidating to install a new thermostat, without the expense of a serviceman.

Consumers are also benefiting by having diagnostic capabilities as part of a digital thermostats. Traditionally, these diagnostic systems helped a technician repair a failure by the diagnostics pointing them to a problem area. Recently, however, diagnostic systems have taken a more active role in the system, often times predicting problems before a major system failure occurs. This helps the consumer because they have some warning to repair the system before a failure occurs that causes them to have no heating and/or cooling. It also, in some cases, will turn the heating and/or cooling system off to prevent further damage to the system; thus saving the consumer repair dollars. It may also alert the consumer to a system that is wasting energy because service of some type is needed.

The major drawback to this diagnostic system to date is that they require additional or different wiring and or equipment than past systems. They are also typically not suited for retrofitting into an existing system.

Therefore a need has arisen for an improved thermostat.

### BRIEF SUMMARY OF THE INVENTION

In the present invention, a thermostat comprises processing circuitry, a housing for mounting on an AC power source, and wireless communication circuitry for sending control signals from the processing circuitry to control an air conditioning unit.

The present invention provides significant advantages over the prior art. First, the thermostat can be placed in any location in a house or business where there is AC power, and thus is not limited to locations where the control wires have been installed. Second, the thermostat can perform functions requiring increased power, such as processor intensive functions and wireless communications, which would not be realistic using battery power or power stealing techniques.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIG. 1 illustrates a block diagram of an improved thermostat;

FIGS. 2a through 2b illustrate diagnostic warnings provided by the improved thermostat of FIG. 1;

FIG. 3 illustrates an interface generated on an external monitor that interacts with a remote wireless or wired device;

FIGS. 4a through 4b illustrate a thermostat system that allows various different thermostat models to use the same sub-base for ease of installation;

FIG. 5 illustrates a thermostat that turns on a scent dispenser when the fan terminal is energized;

FIGS. 6a and 6b illustrate thermostats with glow-in-the-dark lettering and buttons;

FIG. 7 is a flow chart describing operation of a training mode for automatically generating schedules;

FIG. 8 illustrates a block diagram of a prior art configuration for controlling an HVAC system;

FIGS. 9a and 9b illustrate a thermostat for receiving power through a power outlet;

FIGS. 10a and 10b illustrate a thermostat for receiving power through a light switch;

FIGS. 11a and 11b illustrate a sensor for receiving power through a power outlet;

FIG. 12 illustrates a first configuration for controlling a HVAC system using the devices of FIGS. 9-11 using a wireless receiver;

FIG. 13 illustrates a first configuration for controlling a HVAC system using the devices of FIGS. 9-11 using a wired thermostat;

FIG. 14 illustrates a prior art configuration of a dampered air conditioning system;

FIG. 15 illustrates a dampered air conditioning system without a zoning control panel;

FIG. 16 illustrates a thermostat that is running an approved “Energy Star” program or program event

FIG. 17 illustrates a thermostat being programmed that does not meet the energy star specification;

FIG. 18 illustrates a thermostat being programmed that is returned to a program which meets the energy star specification;

FIG. 19 illustrates a thermostat housing with a removable badge.

### DETAILED DESCRIPTION OF THE INVENTION

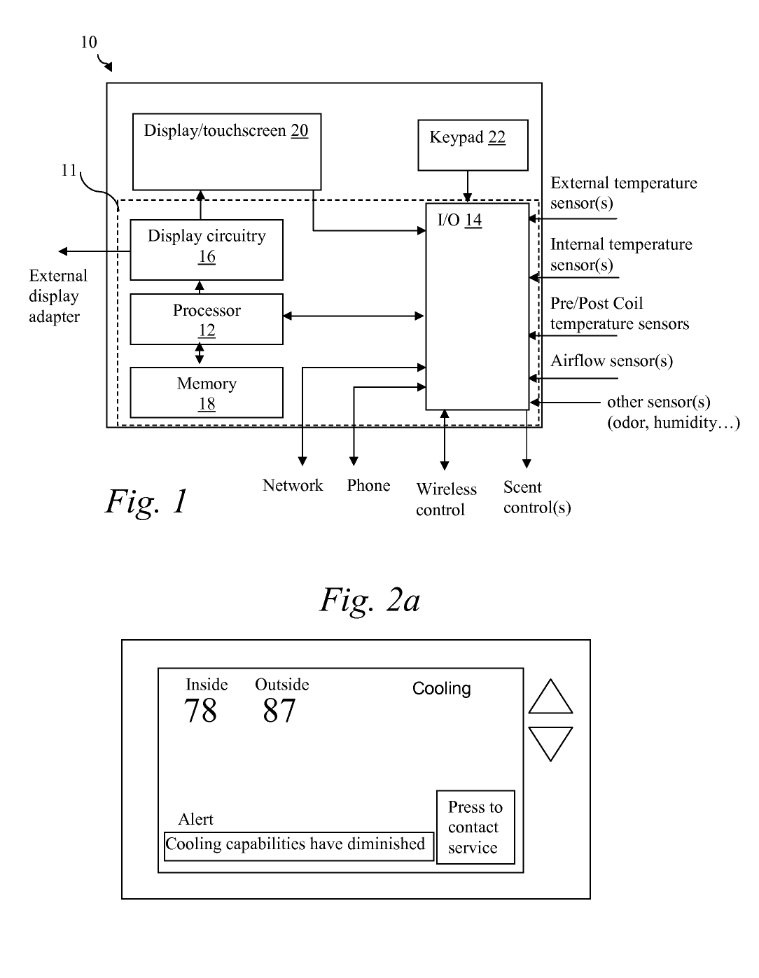

The present invention is best understood in relation to FIGS. 1-18 of the drawings, like numerals being used for like elements of the various drawings.

FIG. 1 illustrates a block diagram of an improved thermostat 10; it should be understood that an actual implementation of the thermostat of FIG. 1 could include more or less features as desirable.

A processing subsystem 11 includes a processor 12, input/output circuitry (I/O) 14, display circuitry 16 and memory 18. The processor 12, which could be, for example, a microprocessor, microcontroller, or digital signal processor, communicates with the display circuitry 16 and the memory 18. The display circuitry controls the display/touchscreen 20 for the thermostat 10, as well as an external display adapter, which can be used to connect the thermostat to an external monitor, such as a computer monitor or a television. If a touchscreen is implemented, the output is sent to I/O system 14, along with any outputs from a keypad 22.

The I/O system 14 also receives multiple diagnostic inputs of data that may be useful in determining if the heating and air conditioning equipment is malfunctioning or requires maintenance. In the illustrated embodiment, the I/O system receives input from external temperature sensors (sensors to determine the outside temperature), internal temperature sensors (sensors to determine various temperatures inside the house), coil temperature sensors (measuring the temperature drop across the coil), and airflow sensors which measure airflow at various points in the system.

Additionally, I/O system 14 may have advanced communication capabilities. A wireless/wired control input allows the thermostat 10 to communicate with devices through a computer network or through direct wireless communications with a computing device or a remote control (for example, an infrared (IR) or radio frequency (RF) remote control commonly used in connection with electronic equipment).

A scent control signal actives one or more internal or external scent dispensers. Since the thermostat controls when the fan of the HVAC system is on, the scent control signal can be initiated only when the fan is on to better disperse the scent more evenly throughout the house or building, or section thereof. The air fresheners could be internal to the thermostat or could be mounted externally in many ways including magnetically or mechanically attaching to supply and/or return air grills. An external embodiment of the air fresheners would communicate wirelessly with the thermostat. Additionally, air quality sensors could be coupled to the thermostat 10 through the I/O system 14 to provide information on when scent is needed.

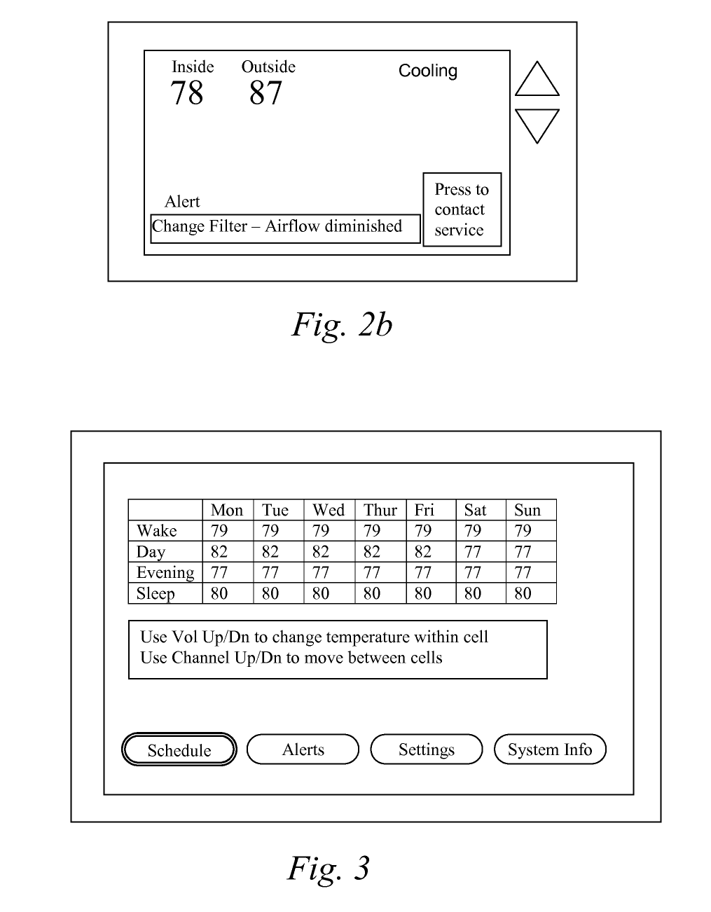

In operation, the thermostat 10 uses the diagnostic inputs, such as internal/external temperatures, coil temperature drop, and airflow to determine when a problem has occurred in the system or when maintenance is beneficial. For example, the thermostat 10 can use historical data to diagnose a heating and/or cooling system. By comparing the amount of time needed in the past to satisfy itself at a given outdoor temperature and/or temperature range and/or outdoor temperature average to the time required during a recent or current cycle, problems, such as a loss of refrigerant, can be identified. As an example of the capability, assume that in the first year of operation, the thermostat determined that the building requires 10 minutes to satisfy a call for cooling if the outdoor temperature was 90 degrees. During recent cycles, it takes 15 minutes to satisfy the thermostat when the outdoor temperature is 90 degrees. The thermostat deduces that a technician should inspect the system. In response to learning of this condition, the thermostat displays a warning, such as that shown in FIG. 2a. If the thermostat is connected to the network or to a telephone system, it could contact the service company to schedule an inspection of the problem. Since the information could include the source of the problem, this allows the service person to bring any necessary equipment or parts to the inspection.

Similarly, air flow sensors could determine a decrease in air flow, generally indicating that the air filter is clogged. A warning is shown in FIG. 2b, and the user could either replace/clean the filter or contact the service company. In other embodiments, the display could specify the size and type of filter, or provide instructions for removing and cleaning the filter.

The thermostat could also diagnose a heating and/or cooling system by comparing the rate of indoor temperature change in the past to a given outdoor temperature and/or temperature range and/or outdoor temperature average to the rate of indoor temperature change during a recent or current cycle. For example, the thermostat might determine that during a first year of operation, the indoor temperature changed at one degree per 10 minutes during a cooling cycle if the outdoor temperature was 90 degrees. If, during recent cycles, the system takes 15 minutes to change the indoor temperature by one degree, the thermostat would deduce that a technician should inspect the system.

The thermostat could also diagnose a heating and/or cooling system by comparing the amount of time that the heating and cooling system ran in the past during a specified length of time at a given outdoor temperature and/or temperature range and/or outdoor temperature average to the length of time required during a recent or current time period. For example, in a first year of operation, the thermostat might determine that a building would require two hours of operation to satisfy a call for cooling during a 24-hour period if the outdoor temperature was 90 degrees. If during recent cycles it takes three hours of operation during a 24 hour period to satisfy the thermostat when the outdoor temperature is 90 degrees, the thermostat would deduce that a technician should inspect the system.

The thermostat can diagnose a heating and/ or cooling system by comparing past performance with current performance and can alert the user of several potential issues including: low refrigerant, refrigerant leak, cracked heat exchanger, reduced gas pressure, air conditioning coil debris buildup, dirty air filter, closed vents, newly occurring duct leaks, etc.

FIG. 3 illustrates a user interface where the user controls the thermostat through a remote control of the type typically used for controlling electronic equipment such as televisions and stereos. The interface is displayed on a television monitor or computer monitor. The thermostat could be directly coupled to a video input to the monitor, or may be coupled to a satellite interface controller that provides the interface to the monitor and receives the signals from the remote control and passes them to the thermostat via a wired or wireless connection. The interface controller would also receive signals from the thermostat indicating current settings and status.

This aspect of the invention provides the advantage that a large viewing screen can provide a more sophisticated interface for setting the thermostat by a user, and the remote control is a familiar means for entering information.

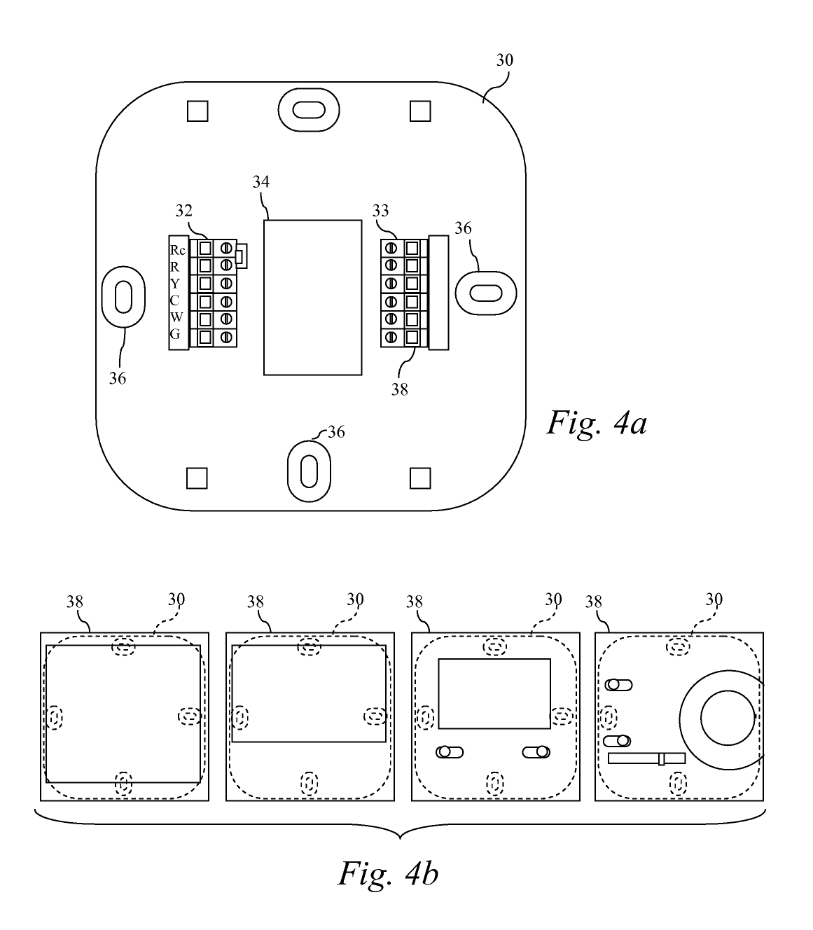

FIGS. 4a-b illustrate a thermostat sub-base system. It is now common in the industry for a single manufacturer to offer thermostat platforms spanning multiple price points (good, better, best). One major shortcoming of current designs is that changing the thermostat, even within the offerings of a single manufacturer, are generally too complicated for someone other than an air conditioning serviceman or electrician to install. If a sub-base is provided with the thermostat, it is generally not compatible with another platform. The thermostat of FIGS. 4a-c shows a sub-base that is designed to couple with multiple thermostats. For example a thermostat can be installed in a home and then, at a later date, a different thermostat can be installed as an upgrade or repair without reinstalling a sub-base.

FIG. 4a illustrates a sub-base in a system where several different thermostat platforms can all share the same sub-base. Sub-base 30 includes color coded terminals 32, preferably quick connect terminals, which are colored to match the colored wires from the heating/cooling system to the thermostat. For example, red (power), yellow (cooling), white (heating) and green (fan) wires connect to the “R” red, “Y” yellow, “W” white and “G” green terminals, respectively. The terminals are either colored the same color as the wire, or a colored area is placed adjacent to each terminal 32. Additional terminals 33 are provided for wires that are not color coded. A hole 34 provides a pass-through for the wires and mounting holes 36 provide holes for receiving screws or anchors for mounting the sub-base 30. When a thermostat is mounted on the sub-base, contacts on the back of the thermostat make an electrical connection with the terminals 32 and 33.

The heater/ cooling system installer will wire the sub-base according to the type of devices installed—for example, the sub-base will be wired according to wither it is a single-stage gas system, a single-stage heat pump system, a multi-stage gas system, or a multi-stage heat pump system. The owner need not know the specifics of the heating/cooling system. When the thermostat is coupled to the sub-base, it recognizes the system upon which it is installed from the sub-base 30, and automatically configures itself for that particular system. For example, if the R, W, Y and G terminals of the sub-base 30 are connected to the wires, the thermostat would recognize the system as be a standard single stage heating and cooling system with a fan, and configure itself accordingly. A multistage gas would use the R, W, Y and G terminals along with an additional W1 or W2 terminal.

FIG. 4b illustrates multiple different thermostat types 38 coupled to a single base system. This provides many advantages. First, the homeowner or building owner can easily replace a defective thermostat or upgrade to a better thermostat. Second, builders can offer a range of thermostats and easily and cheaply install whatever model is selected by the buyer.

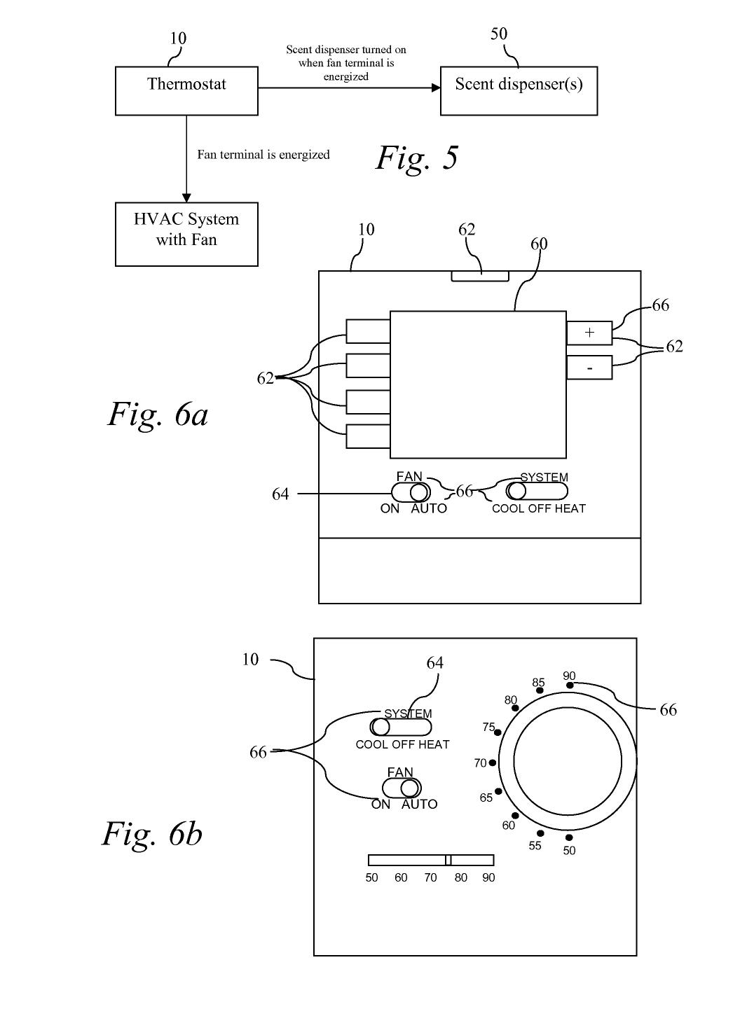

Operation of the air fresheners (scent dispensers) is shown in FIG. 5. The scent dispensers 50 are preferably enabled only during periods when the fan of the HVAC system is energized, such that the scent will be better dispersed by the air flow provided by the fans. Scent dispensers could be triggered according to a schedule, periodically, or in response to odor detection.

FIGS. 6a and 6b illustrate the use of glow in the dark pigment to illuminate important features of the thermostat 10 to reduce energy drain caused by providing a lighting source, typically an LED, to illuminate the display and/or keys of the thermostat. In this embodiment, glow-in-the-dark buttons or lettering allows for the benefits of light in low light conditions without any consumption of power. Glow-in-the-dark technology can be used to illuminate a display 60, buttons 62 (including a button for auxiliary lighting), switches 64, brand name plates 66, and text on the thermostat shown temperature or other information.

In one embodiment, LUMINOVA, a phosphorescent pigment made by NEMOTO & CO. of Tokyo Japan, is used. Luminova pigments are based on strontium oxide aluminate chemistry, as opposed to other phosphorescent pigments which are based on either zinc sulfide or on radioisotopes. Luminova provides a much longer afterglow period and brightness and is free of hazardous and radioactive substances.

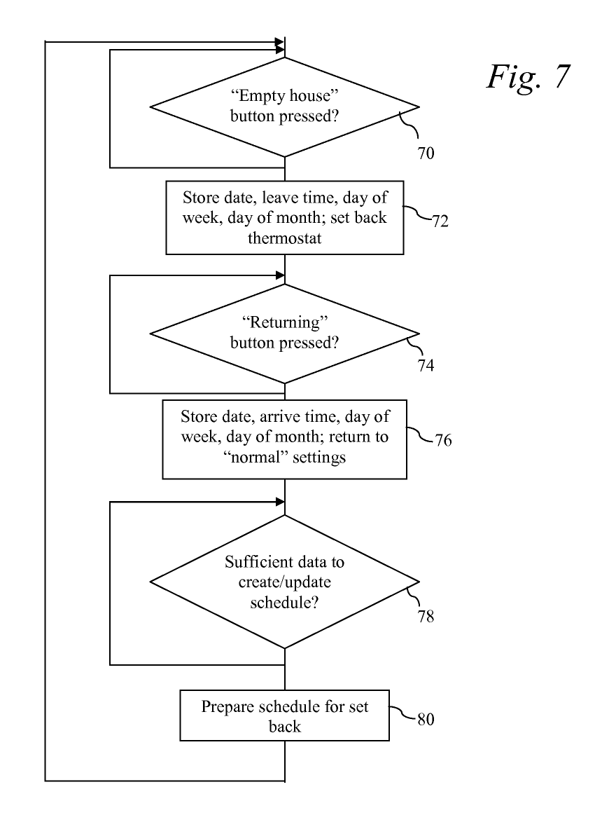

FIG. 7 illustrates operation of a thermostat 10 which includes a training mode under control of processor 12 to determine an optimal or near optimal schedule for temperature set-back, without requiring the user to enter the temperatures. In this embodiment, it is assumed that the thermostat has virtual or physical keys for “empty house” (house unoccupied) and “returning” (at least one person returns to house).

Once the empty house button is pressed in step 70, the day, time, day of month (and other information, if desired) is entered into a database (for example, in memory 18) in step 72, and the thermostat is set back to a lower temperature (for heating) or a higher temperature (for cooling). Upon someone pressing the returning button in step 74, the normal temperature settings are restored in step 76 and the time and date information is stored in the memory 18. In step 78, once sufficient information has been gathered to establish fairly certain trends, a schedule is prepared for the thermostat in step 80. The schedule can be refined by continuing to press the empty house and returning buttons as appropriate.

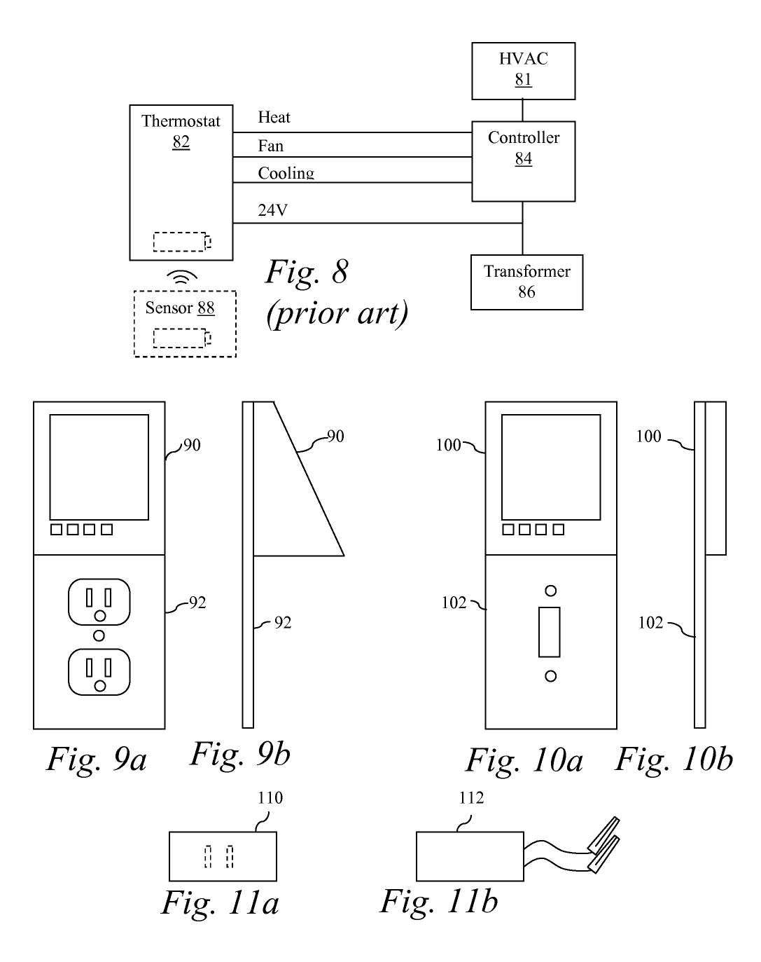

FIGS. 8 illustrates a typical configuration of a prior art air conditioning (HVAC) system 81. A thermostat 82 is connected to a controller 84, typically located physically near an interior portion of the HVAC system. The controller receives 24V DC power through a transformer 86. The controller receives three signals from the thermostat (Heat, Cooling and Fan) and controls various parts of the HVAC system responsive thereto. Optionally, one or more remote sensors 88 send signals to the thermostat 82; for example, a sensor 88 may send temperature information from a remote location in the house to thermostat 82. As discussed above, while the thermostat receives a 24V signal, it is not connected to a common (unless an additional wire is installed) and therefore cannot perform functions which require significant current, unless a battery is installed. Batteries, of course, must be periodically replaced, which is inconvenient for the user.

FIGS. 9a-b, 10a-b and 11a-b illustrate devices that may be used to control an HVAC system using readily available AC power from an existing light switch or an existing power outlet.

FIGS. 9a and 9b illustrate front and side views of a thermostat 90 that is coupled to a power outlet 92. The thermostat is therefore positioned to receive household current from the power outlet to perform any desired function. Included in thermostat 90 is wireless communication circuitry to communicate with other devices, either using a standard wireless protocol, such 802.11b/g, or a proprietary wireless communication protocol. Thermostat 90 could also include a lithium or other type of rechargeable battery to provide backup power, or the AC power system could be used to charge the rechargeable battery, and the battery itself could be used to power the thermostat 90. The thermostat could be coupled to the power using wires with connectors to attach to the terminals on the outlet (inside the circuit box) or it could plug into the outlet.

FIGS. 10a and 10b illustrate front and side views of a thermostat 100 that is coupled to a light switch 102. The thermostat 100 is therefore positioned to receive household current from the power connection to the light switch to perform its functions. Again, thermostat 100 includes wireless communication circuitry to communicate with other devices, either using a standard wireless protocol, such 802.11b/g, or a proprietary wireless communication protocol. As with thermostat 90, a lithium rechargeable battery could be used to provide backup or primary power to the thermostat 100.

FIG. 11a illustrates a sensor 110 which can be plugged into a power outlet to send information on one or more characteristics (such as temperature, humidity, odor, and so on) to another device which controls the HVAC system based, at least in part, on the information. FIG. 11b illustrates a sensor 112 which is similar to the sensor of FIG. 11a, with the exception that sensor 112 is coupled to contacts on the power outlet inside of the circuit box, rather than using one of the available outlets. The connection could be made, for example, by using alligator clips or a similar connector. This embodiment could also be used in connection with a light switch. Both of the sensors use wireless communication to send information.

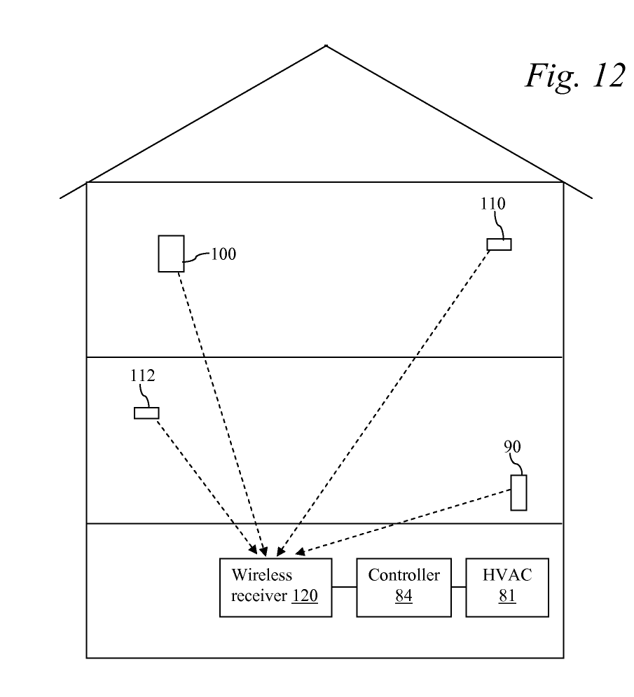

FIG. 12 illustrates a first embodiment of a household HVAC system using the devices of FIGS. 9-11. In the illustrated embodiment, a light switch thermostat 100 and a sensor 110 are positioned in desirable locations on the second floor of a house. A power outlet thermostat 90 and sensor 112 are located on the first floor. Each thermostat or sensor communicates with a wireless receiver 120 (wireless receiver 120 could also be configured to transmit information to the thermostats 90 and 100). Receiver 120 sends information to the controller 84 responsive to information received from the thermostats 90 and 100 and the sensors 110 and 112. Controller 84 then controls the components of the HVAC system.

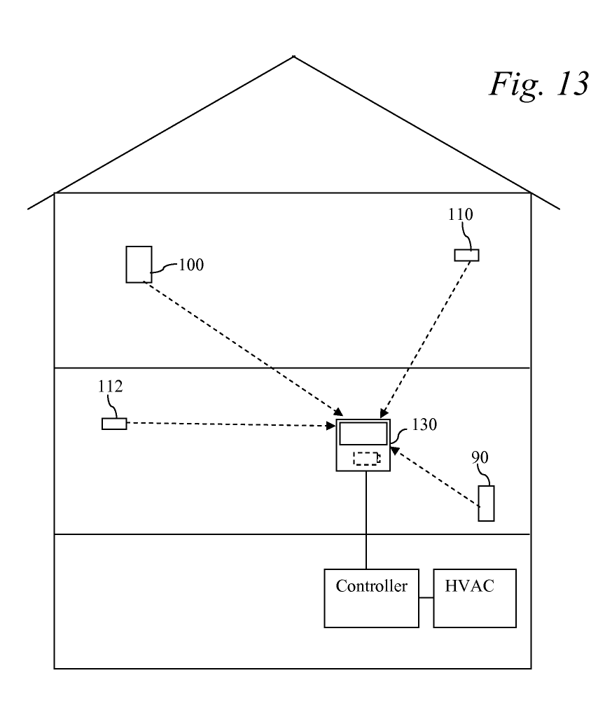

FIG. 13 illustrates a second embodiment of a household HVAC system using the devices of FIGS. 9-11. In this embodiment, as in FIG. 12, a light switch thermostat 100 and a sensor 110 are positioned in desirable locations on the second floor of a house. A power outlet thermostat 90 and sensor 112 are located on the first floor. In FIG. 13, however, each thermostat or sensor communicates with a thermostat 130 (thermostat 130 could also be configured to transmit information to the thermostats 90 and 100). Thermostat 130 may be battery powered, or coupled to a common connection, and sends information to the controller 84 responsive to information received from the thermostats 90 and 100 and the sensors 110 and 112, along with information that it may detect itself. Controller 84 then controls the components of the HVAC system.

The embodiment show in FIGS. 9-13 provides significant advantages. First, the availability of power supplied directly or indirectly from the household power provides increased computing power, wireless communication (which would not be available from a better powered or a power stealing thermostat because of the energy consumed by wireless communications), improved reliability, and reduced service charges.

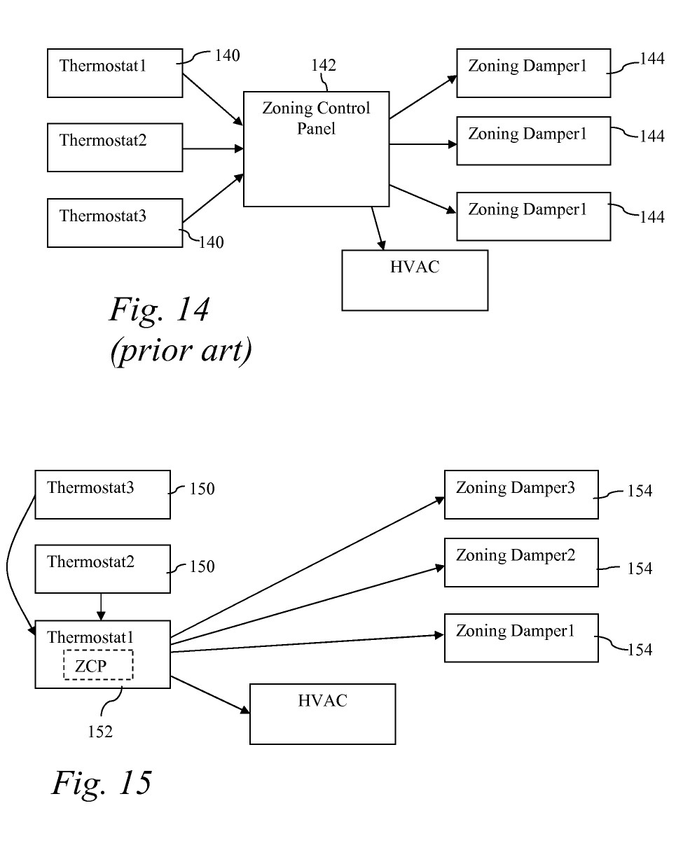

As shown in FIGS. 12 and 13, multiple thermostats may be used to control an HVAC system. Typically, when multiple thermostats are used to control a single heater/cooling system, the flow of conditioned air is controlled by one or more dampers through a zoning control panel. FIG. 14 illustrates such an arrangement as known in the prior art, where three thermostats 140 are connected to a zoning control panel 142. Zoning control panel is connected to three zoning dampers 144. In this embodiment, the thermostats must each communicate with the zoning control panel 142. The zoning control panel 142 is wired or wirelessly communicates with the zoning dampers 144. The zoning control panel 142 is also connected to see HVAC furnace and/or cooling system. The zoning control panel 142 performs some basic logic functions related to the air conditioning needs and decides whether the zone dampers 144 should be open or closed based on the thermostat's reading in that zone.

FIG. 15 illustrates a system which eliminates the need for a zoning control panel. In this embodiment, thermostats 150 communicate (wirelessly) with a main thermostat 152. The main thermostat 152 includes the functionality of the zoning control panel 142; hence, it controls the HVAC system and also controls the individual zoning dampers.

For example, in a two story home, the main thermostat 152 would be connected to the existing thermostat wiring on the first floor, which is connected to the heating/cooling systems. This thermostat could be connected to the HVAC system using the existing wiring. A second thermostat 150 could be installed on the second floor. The second thermostat 150 could communicate with the main thermostat 152 using wireless communications. The main thermostat 152 would then communicate with the dampers 154 for both the first and second floors, along with communicating to the HVAC system.

This embodiment provides the advantage of reducing installation time and reducing the number of products needed for a zoning system, thereby making a zoning system more economical to install.

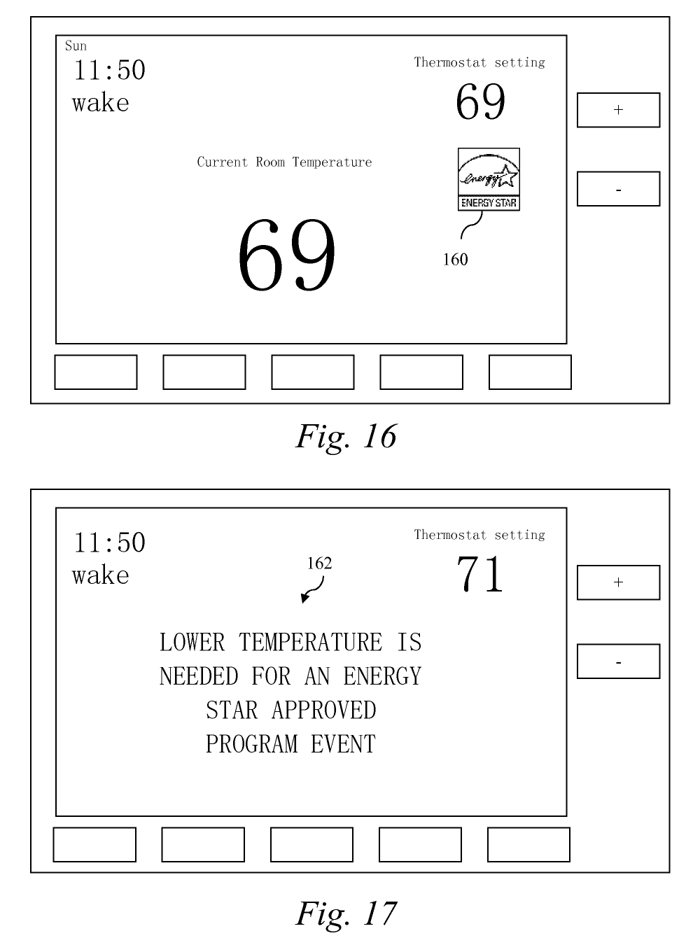

FIG. 16 shows the user interface of a thermostat when a program in compliance with the Energy Star program is being executed by the thermostat. The Energy Star logo 160 is visible to the user.

FIG. 17 illustrates the user interface of a thermostat when a non-compliant program is being executed by the thermostat due to an excessively high heating setting or an excessively low cooling setting. In this instance, the Energy Star logo 160 is no longer visible and a warning 162 is displayed. Preferably, an explanation is given to help the user change the program to compliance, such as instructing the user to increase or decrease the temperature setting for the program.

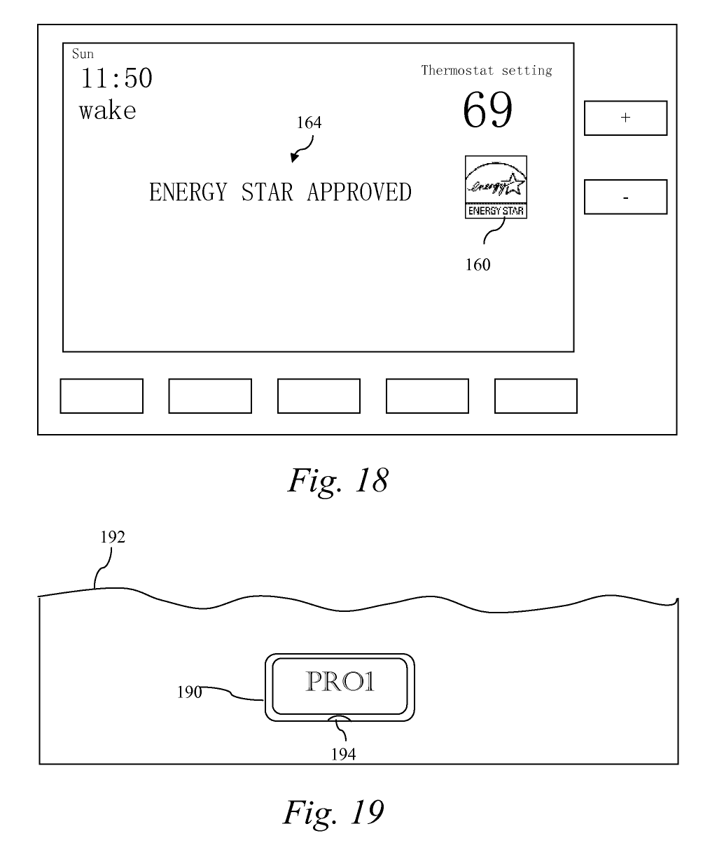

In FIG. 18, after changing the program in accordance with the directions, the Energy Star logo 160 is restored to show compliance along with an approval message 164.

Current Energy star setting for different time periods are shown in Table 1.

TABLE 1
Energy Star Setpoint Temperatures

| Setting | Heat Temperature | Cooling Temperature |
|---|---|---|
| Wake | ≦70° F. | >78° F. |
| Day | Set-back at least 8° F. | Set-up at least 7° F. |
| Evening | ≦70° F. | >78° F. |
| Sleep | Set-back at least 8° F. | Set-up at least 4° F. |

This improved thermostat uses the energy star specification to show the user whether or not the program event they are inputting is energy star approved. Other specifications could be used as desired.

The rules for Energy Star compliance are added to a non-volatile memory in the thermostat at the time of manufacturer and, preferably, can be updated periodically, either by the user or by an air conditioning serviceman. Alternatively, the rules could be at an external location accessible to the thermostat via a data network. The rules are compared to the actual program settings using a processing device within the thermostat to determine whether or not the program is compliant. If a program setting is not compliant, the user is notified and may change the program setting and the compliance symbol will be restored.

FIG. 19 illustrates a removable badge 190 that can be applied to the housing 192 of the thermostat. In the preferred embodiment, the badge has a metal backing which is attracted to a magnetic implant on the housing 192. The badge has a small indentation 194 that can be used to remove the badge.

The removable badge 190 allows the installer to add its name and phone number to the thermostat so that the user can easily contact the installer if there is a problem, or if additional services are desired. The badge can also be replaced with brand names of equipment providers which sell the thermostat under their own mark.

Although the Detailed Description of the invention has been directed to certain exemplary embodiments, various modifications of these embodiments, as well as alternative embodiments, will be suggested to those skilled in the art. The invention encompasses any modifications or alternative embodiments that fall within the scope of the Claims.

1. A thermostat comprising:
processing circuitry;
a housing for mounting on an AC power source;
wireless communication circuitry for sending control signals from the processing circuitry to control an air conditioning unit.

2. The thermostat of claim 1 wherein the housing mounts on a light switch power connection.

3. The thermostat of claim 1 wherein the housing mounts on a power outlet.

4. The thermostat of claim 1 and further comprising a wireless receiver coupled to the air conditioning unit for receiving signals from the wireless communication circuitry and controlling the air conditioning unit responsive thereto.

5. The thermostat of claim 1 and further comprising a second thermostat wired to the air conditioning unit, said second thermostat having a wireless receiver to receiving signals from the wireless communication circuitry.

6. A thermostat system comprising:
a sub-base for connection to a plurality of wires for connection to an air conditioning unit;
a plurality of thermostats for connection to the sub-base, such that connection of a selected one of the thermostats to the sub-base will connect the selected thermostat to the wires.

7. The thermostat of claim 6 wherein the sub-base has a plurality of color-coded terminals.

8. The thermostat of claim 6 wherein the plurality of thermostats have different features.

9. The thermostat of claim 6 wherein at least some of said plurality of thermostats have processing circuitry for determining a type associated with the air conditioning unit and for configuring the selected thermostat according to the detected type.

10. The thermostat of claim 9 wherein said type can be either single-stage or multi-stage.

11. The thermostat of claim 9 wherein said type can be either gas or heat pump.

12. A damper control system comprising:
a plurality of electronically controlled dampers;
a plurality of thermostats, each for controlling temperature in a predetermined area, said plurality of thermostats including:
a main thermostat for controlling the dampers; and
one or more secondary thermostats in communication with the main thermostat.

13. The damper control system of claim 12 wherein said main thermostat wirelessly communicates with the dampers.

14. The damper control system of claim 12 wherein the secondary thermostats wirelessly communicate with the main thermostat.

15. The damper control system of claim 12 wherein the main thermostat controls an air conditioning unit.
